(19) United States
(12) Patent Application Publication
(10) Pub. No.: US 2025/0050872 A1
(43) Pub. Date: Feb. 13, 2025

(54) VEHICLE CONTROL SYSTEMS FOR EVASIVE STEERING MANEUVERS

(71) Applicant: GM GLOBAL TECHNOLOGY OPERATIONS LLC, Detroit, MI (US)

(72) Inventors: Milad JALALIYAZDI, Richmond Hill (CA); Reza ZARRINGHALAM, Whitby (CA); Brandon Alan SCHOETTLE, Farmington Hills, MI (US); Yi Guo CLASER, Novi, MI (US); Chad T. ZAGORSKI, Clarkston, MI (US); Parisa MAHVELATISHAMSABADI, North York (CA); Paul A. ADAM, Milford, MI (US); Tetyana V. MAMCHUK, Walled Lake, MI (US)

(21) Appl. No.: 18/448,328

(22) Filed: Aug. 11, 2023

(51) Int. Cl. B60W 30/09; B60W 30/095; B60W 40/08; B60W 50/14

(52) U.S. Cl. CPC B60W 30/09; B60W 30/0956; B60W 40/08; B60W 50/14; B60W 2050/143; B60W 2050/146; B60W 2540/223

(57) ABSTRACT

A vehicle control system for evasive steering maneuvers includes a forward object detector configured to detect objects in a driving path of a vehicle, a steering wheel configured to control a steering direction of the vehicle, a vehicle user interface configured to display a visual indication to a driver and generate audio for the driver, and a vehicle control module configured to identify, via the forward object detector, an object in the driving path of the vehicle, determine an estimated time to collision with the object, and in response to the estimated time to collision being less than a specified time threshold, execute at least one of providing a visual indication of a recommended evasive steering maneuver to the driver via the vehicle user interface, generating an audio alert of the recommended evasive steering maneuver, applying steering torque to the steering wheel to indicate the recommended evasive steering maneuver.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to vehicle control systems for evasive steering maneuvers, including determining a preferred side of a vehicle for a recommended evasive steering maneuver.

A current trend in the automotive industry is to introduce safety systems for avoiding or mitigating collisions. Some of the introduced safety systems, such as Forward Collision Avoidance Systems (FCAS), are aimed at avoiding or mitigating forward collisions between a vehicle hosting such a system and an oncoming vehicle. For example, a forward collision alert may be issued to a driver when the host vehicle is quickly approaching a closest in-path vehicle or a vulnerable road user.

### SUMMARY

A vehicle control system for evasive steering maneuvers includes at least one forward object detector configured to detect one or more objects in a driving path of a vehicle, a steering wheel configured to control a steering direction of the vehicle, a vehicle user interface configured to display a visual indication to a driver and generate audio for the driver, and a vehicle control module configured to identify, via the at least one forward object detector, an object in the driving path of the vehicle, determine an estimated time to collision with the object, and in response to the estimated time to collision being less than a specified time threshold, execute at least one of providing a visual indication of a recommended evasive steering maneuver to the driver via the vehicle user interface, generating an audio alert of the recommended evasive steering maneuver, applying steering torque to the steering wheel to indicate the recommended evasive steering maneuver.

In other features, the vehicle control module is configured to, in response to the estimated time to collision being less than at specified time threshold, apply steering torque to the steering wheel to rotate the steering wheel about a steering axis of the steering wheel.

In other features, the vehicle control module is configured to apply steering torque as a series of individual pulses which are spaced from one another over a time period.

In other features, the vehicle includes a steer-by-wire vehicle steering apparatus, and the vehicle control module is configured to apply steering torque to the steering wheel only without applying steering torque to wheels of the vehicle.

In other features, the vehicle control module is configured to determine whether the driver currently has at least one hand in contact with the steering wheel, and apply steering torque to the steering wheel only in response to a determination that the driver currently has at least one hand in contact with the steering wheel.

In other features, the vehicle control module is configured to, in response to the estimated time to collision being less than the specified time threshold, display the visual indication of a recommended evasive steering maneuver to the driver on a display of the vehicle user interface, and the visual indication of the recommended evasive steering maneuver includes a recommended steering direction for the recommended evasive steering maneuver.

In other features, the vehicle control module is configured to, in response to the estimated time to collision being less than the specified time threshold, generate the audio alert of the recommended evasive steering maneuver, and the audio alert of the recommended evasive steering maneuver includes a chime indicating a steering direction for the recommended evasive steering maneuver.

In other features, the vehicle control module is configured to obtain one or more vehicle operating condition parameters via one or more vehicle sensors, and determine a preferred steering direction for the recommended evasive steering maneuver, according to the one or more vehicle operating condition parameters, the preferred steering direction indicative of a left or right steering direction have a higher likelihood of safety compared to an opposite one of the left or right steering direction.

In other features, at least one the visual indication of the recommended evasive steering maneuver includes the preferred steering direction, the audio alert of the recommended evasive steering maneuver includes the preferred steering direction, or the steering torque applied to the steering wheel to indicate the recommended evasive steering maneuver includes the preferred steering direction.

In other features, determining the preferred steering direction includes applying one or more hard constraints to the one or more vehicle operating condition parameters, each of the hard constraints indicative of a parameter value that prohibits selection of a steering direction.

In other features, the one or more hard constraints include at least one of a collision with a traffic threat, crossing of a hard barrier or non-drivable space, or current vehicle motion above a safe maneuver threshold value.

In other features, determining the preferred steering direction includes applying one or more soft constraints to the one or more vehicle operating condition parameters, each of the soft constraints indicative of a parameter value indicative of lower likelihood of safety of a steering direction.

In other features, the one or more soft constraints include at least one of relative distance and motion from a traffic threat, a topology of a road on which the vehicle is travelling, and a current motion of the vehicle.

In other features, the specified time threshold is a specified second time threshold, the vehicle control module is configured to initiate a forward collision alert in response to the estimated time to collision being less than a specified first time threshold, and the specified first time threshold is greater than the specified second time threshold.

A method for recommending evasive vehicle steering maneuvers includes controlling, via a steering wheel of a vehicle, a steering direction of the vehicle, detecting, via at least one forward object detector of a vehicle, an object in a driving path of a vehicle, determining, by a vehicle control module, an estimated time to collision with the object, and in response to the estimated time to collision being less than a specified time threshold, executing at least one of providing a visual indication of a recommended evasive steering maneuver to a driver via a vehicle user interface of the vehicle, generating an audio alert of the recommended evasive steering maneuver, and applying steering torque to the steering wheel to indicate the recommended evasive steering maneuver.

In other features, the method includes applying steering torque includes applying steering torque to the steering wheel to rotate the steering wheel about a steering axis of the steering wheel.

In other features, the steering torque is applied as a series of individual pulses which are spaced from one another over a time period. In other features, the vehicle includes a steer-by-wire vehicle steering apparatus, and applying steering torque includes applying steering torque to the steering wheel only without applying steering torque to wheels of the vehicle.

In other features, the method includes determining whether the driver currently has at least one hand in contact with the steering wheel, and applying steering torque to the steering wheel only in response to a determination that the driver currently has at least one hand in contact with the steering wheel.

In other features, the method includes displaying the visual indication of a recommended evasive steering maneuver to the driver on a display of the vehicle user interface, and the visual indication of the recommended evasive steering maneuver includes a recommended steering direction for the recommended evasive steering maneuver.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example embodiment of a vehicle control system for evasive steering maneuvers.

FIG. 2 is a diagram depicting an example implementation of the system of FIG. 1.

FIG. 3 is a flowchart depicting an example process for controlling an evasive steering maneuver alert.

FIG. 4 is a flowchart depicting an example process for determining a type of alert for an evasive steering maneuver.

FIG. 5 is graph depicting an example process for providing pulses to apply steering wheel torque.

FIGS. 6 and 7 are diagrams illustrating example embodiments for determining a preferred side of the vehicle for an evasive steering maneuver.

In the drawings, reference numbers may be reused to identify similar and/or identical elements.

### DETAILED DESCRIPTION

Evasive steering is a front impact mitigation feature that becomes more effective than braking at higher closing speeds. Some example embodiments described herein provide vehicle control systems and methods for automated recommendation of an evasive steering maneuver to a driver, as a more effective collision avoidance maneuver.

For example, some drivers may not intuitively consider an evasive steering maneuver as a response to high stress, quickly evolving collision risk situations. Some example embodiments provide evasive driving maneuver recommendations or “cues” to prompt the driver to consider an evasive steering maneuver in a preferred direction (e.g., a left or right steering direction that has been determined as the safest option for an evasive steering maneuver based on sensed vehicle operation parameters and surrounding objects). These evasive steering maneuver recommendations may include, for example, steering wheel nudges via small and brief application of torque to the steering wheel, haptic seat alerts, side dependent audio chimes, side dependent visual notifications, etc.

In various implementations, the vehicle control module may ensure that all necessary conditions for evasion are met (such as no obstacles on at least one side of the vehicle), and then applies brief but noticeable steering torque to the steering wheel to cue the driver to take an evasive steering maneuver. In steer-by-wire systems, the torque may only be applied to the steering wheel, such that the road wheels/vehicle trajectory is not impacted.

In some example embodiments, the steering wheel nudge is only applied if the driver is hands-on, to avoid counter-steering reaction by the driver (e.g., if the driver is hands-off and would react to visual observing the wheel turning by grabbing the wheel and turning in the other direction). The degree of hands-on detection before applying a steering wheel torque may be calibratable.

In addition, or alternatively, a directional visual alert, audio chime, haptic feedback, etc., may be used to prompt the driver. The vehicle control module may be configured to pick a preferred side for evasion based on several factors, such as oncoming traffic, side/rear threats, barriers and safety limits. Unlike conventional alerting methods, in addition to the presence of a possible hazard, a method to avoid the hazard is suggested to the driver via a recommended evasive steering maneuver.

Example embodiments may be implemented where the vehicle control module provides an alert only and steering control is fully implemented by the driver, the vehicle can assist in completing an evasive steering maneuver after initiation by the driver, or the recommended evasive steering maneuver is fully implemented by an automated driving system of the vehicle. For example, a “driver initiation” implementation may engage and assist to complete the evasive maneuver after a driver starts the steering wheel turn, and then stabilize the vehicle after clearing the front threat.

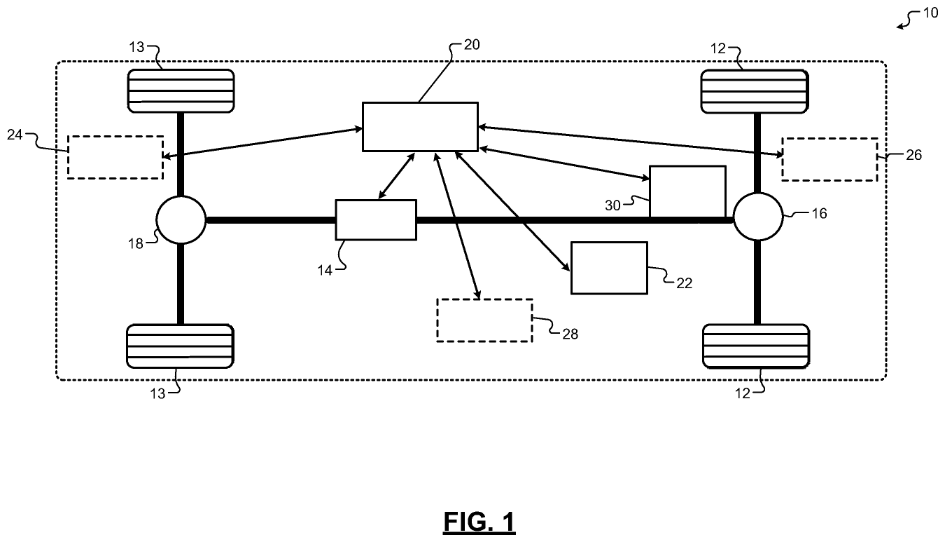

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel 30, an acceleration paddle, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, wheel position sensors, location sensors such as global positioning system (GPS) antennas, etc.). Some sensors may be configured to monitor current motion of the vehicle, acceleration of the vehicle, steering torque, etc.

As shown in FIG. 1, the vehicle 10 includes an optional rear object detector 24, an optional front object detector 26, and an optional side object detector 28. In various implementations, the vehicle 10 may include more or less (or none) of any one of these optional sensors. Each object sensor may include any suitable camera, laser, lidar sensor, etc., which is used to detect objects around the vehicle 10. In some example embodiments, a vehicle object detector may be configured to detect a closest in-path vehicle (CIPV) (e.g., another vehicle in front of a current driving path of the vehicle 10), a vulnerable road user (VRU) (e.g., a pedestrian or cyclist), etc.

The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

As mentioned above, the vehicle 10 may include a steering wheel 30. The vehicle control module 20 may be configured to apply steering torque to the steering wheel 30 to provide a steering wheel nudge, such as a slight rotation of the steering wheel 30 about a steering axis of the steering wheel 30. For example, if the front object detector 26 detects a CIPV having a time to collision (TTC) of less than a specified time threshold (e.g., indicating a potential collision with the other vehicle is likely), the vehicle control module 20 may apply steering torque to the steering wheel 30 to recommend to a driver that they turn the steering wheel to take an evasive steering maneuver around the CIPV.

The vehicle control module may apply a series of pulses of steering torque to the steering wheel 30 to cue the driver, such as a series of approximately 200 millisecond pulses, etc. The pulses may alert the driver, without causing enough steering torque to significantly affect the steering direction of the vehicle. In some example embodiments, a single steering torque pulse may be applied to the steering wheel 30.

Some vehicles may have a steer-by-wire (SBW) system, where the wheels are electronically turned according to a steering wheel input, but the steering wheel is not mechanically connected to the wheels. In that case, the vehicle control module 20 may be configured to apply steering torque to rotate the steering wheel 30, without moving the wheels.

Some vehicles may provide hands-on detection, which includes one or more sensors for determining whether a driver currently has their hands on the wheel. In some example embodiments, the vehicle control module 20 may be configured to apply steering torque to the steering wheel 30 only after determining that a driver currently has hands on the wheel.

The vehicle 10 also includes a user interface 22. The user interface 22 may include any suitable displays (such as on a dashboard, a console, or elsewhere), a touchscreen or other input devices, speakers for generation of audio, etc. In some example embodiments, the vehicle control module 20 may be configured to provide a visual notification of a recommended evasive steering maneuver on the user interface 22, and/or generate an audio alert of the recommended evasive steering maneuver.

The vehicle control module 20 may be configured to determine a preferred side for the recommended evasive steering maneuver. For example, the front object detector 26, the rear object detector 24, the side object detector 28, other vehicle sensors, etc., may be configured to obtain vehicle operation parameters including other vehicles and objects around the vehicle 10, road conditions around the vehicle 10, current motion of the vehicle 10, etc., and determine which side (e.g., left or right) is likely to provide the safest evasive steering maneuver. Based on this determination, the vehicle control module may provide a recommended evasive steering maneuver notification on the preferred side of the vehicle 10, such as a visual notification on the preferred side, an audio chime on the preferred side (or a left/right voice notification), and/or a steering wheel nudge on the preferred side by applying steering torque.

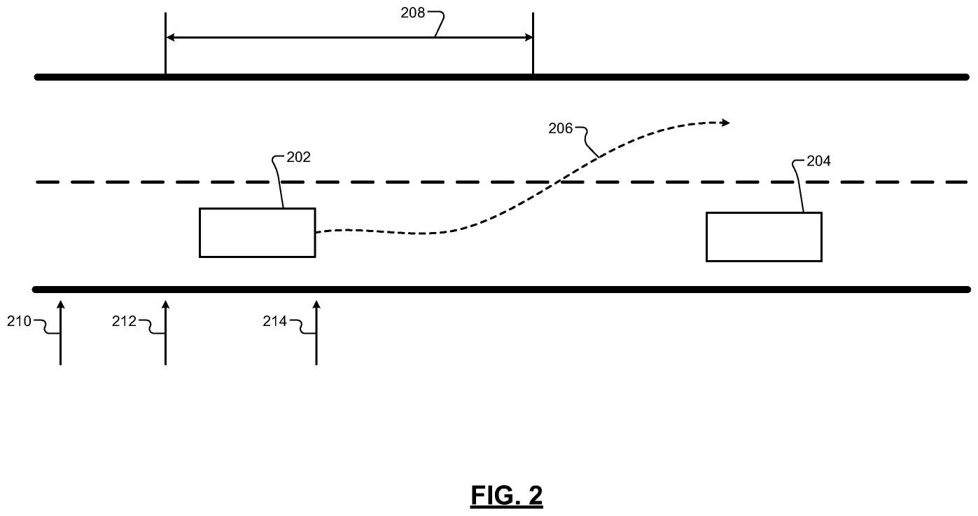

FIG. 2 is a diagram depicting an example implementation of the system of FIG. 1. As shown in FIG. 2, a first vehicle 202 is approaching a second vehicle 204. As the first vehicle 202 approaches the second vehicle 204, the first vehicle 202 may determine an estimated time to collision (TTC) based on, for example, a distance between the first vehicle 202 and the second vehicle 204, relative speeds of the first vehicle 202 and the second vehicle 204, etc.

When the first vehicle 202 is at a first time to collision 210 (or first distance) from the vehicle 204, a vehicle control module of the first vehicle 202 may issue a forward collision alert (FCA). For example, the forward collision alert may simply notify the driver that a possible forward collision risk has been identified.

At a second time to collision 212 (or second distance), the vehicle control module of the first vehicle 202 may initiate a recommended evasive steering maneuver alert. This may include, for example, applying steering torque to nudge the steering wheel, displaying a visual notification of the recommended evasive steering maneuver, generating an audio alert indicative of the recommended evasive steering maneuver, etc.

The second time to collision 212 may be less than the first time to collision 210, or a shorter distance between the first vehicle 202 and the second vehicle 204. In this manner, the vehicle control module may first issue a general forward collision alert, and then subsequently generate a notification of a recommended evasive steering maneuver if the first vehicle 202 continues to get closer to the second vehicle 204 after the forward collision alert.

At the point 214, the driver initiates the evasive steering maneuver. For example, the driver may respond to a steering wheel nudge by turning the steering wheel such that the vehicle 202 follows an evasion path 206 to drive around the second vehicle 204. The evasion path 206 may be manually controlled by the driver, may be automatically controlled if the vehicle is equipped with an automated driving system, etc. In some example embodiments, an indication may be provided to the driver, and if the driver initiates the evasive steering maneuver (such as by manually initiating further rotation of the steering wheel beyond a steering nudge from the vehicle control system), the automated driving system may take over to execute the remainder of the evasive steering maneuver.

For example, an automatic emergency steering (AES) window 208 may indicate a distance where it is determined relatively safe to execute an evasive steering maneuver. Before the AES window 208, it may be safer to first apply braking before determining whether evasive steering is needed. Within the AES window 208, there may be sufficient room for the first vehicle 202 to move to the side before it reaches the second vehicle 204. After the AES window 208, the first vehicle 202 may be too close to the second vehicle 204, such that it is safer to simply apply the brakes to reduce the impact of an unavoidable collision.

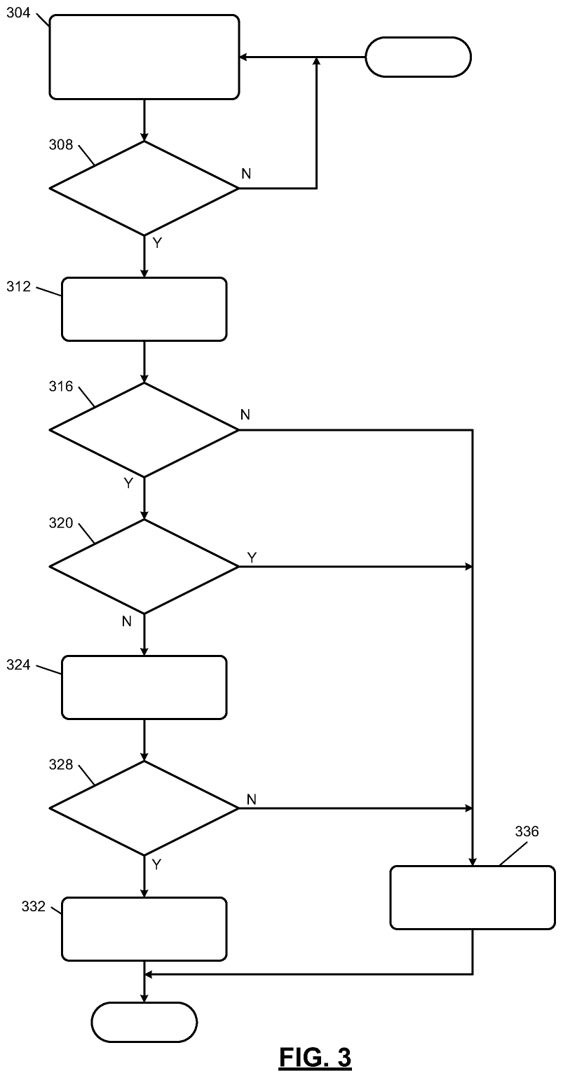

FIG. 3 is a flowchart depicting an example process for controlling an evasive steering maneuver alert. The process may be performed by, for example, the vehicle control module 20 of FIG. 1. At 304, the method begins by monitoring a time to collision (TTC) with a closest in-path vehicle and/or vulnerable road user.

At 308, the vehicle control module is configured to determine whether the TTC is less than a specified first time threshold (e.g., five seconds, three seconds, etc.). If not, the vehicle control module returns to 304 to continued monitoring the time to collision.

If the vehicle control module determines at 308 that the TTC is less than the first threshold, control issues a forward collision alert (FCA) at 312. For example, the vehicle control module may issue a general alert than a forward collision risk is present and the driver should be on alert.

At 316, the vehicle control module determines whether the TTC is less than a specified time threshold. The second time threshold may be less than the specified first time threshold. For example, the first time threshold may be used for a general indication that a forward collision risk is present, while the second time threshold (e.g., two seconds, one second, less than one second, etc.) may indicate the vehicle is even closer to an object in front of the vehicle and evasive action is recommended.

If control determines at 316 that the TTC does not drop below the specified time threshold (e.g., because the vehicle slows down sufficiently, etc.), control proceeds to 336 and no further cue is presented. For example, if after the forward collision alert is generated, the driver applies the brakes and does not get closer to the object in front of the vehicle, it may not be necessary to take any further evasive steering action.

In some example embodiments, the vehicle control module may continue monitoring the TTC at 316 for a specified time period, and only move to 336 after the time period expires. For example, after a FCA is generated, the system may continue monitoring TTC. If the TTC does not drop below the specified second threshold within ten seconds after the FCA, within thirty seconds after the FCA, etc., it may be determined that the driver has avoided the possible collision event.

If the vehicle control module determines at 316 that the time to collision is less than the specified second time threshold, control proceeds to 320 to determine whether a speed of the vehicle is above a safe maneuvering threshold speed. If so, control proceeds to 336 and does not issue a recommended steering maneuver cue (e.g., because the vehicle is already driving too fast to safely execute a steering maneuver).

If control determines at 320 that the vehicle speed is safe for executing an evasive steering maneuver, control determines a preferred escape side at 324. For example, one or more vehicle sensors may be used to obtain a current operation parameters of the vehicle, and a safest side of the vehicle for steering may be determined (e.g., based on the presence of other cars around the vehicle, based on current road topography, based on current movement of the vehicle, etc.).

At 328, the vehicle control module is configured to determine whether and escape sides are available. For example, control may determine whether either side of the vehicle is free of other cars in other adjacent lanes, either side of the vehicle is free of road obstructions, etc. If neither side of the vehicle is determined to be safe for an evasive steering maneuver at 328, control proceeds to 336 and does not issue a recommended steering maneuver cue.

If control determines at 328 that an escape side is available (e.g., because an adjacent lane is free of other vehicles or road obstructions, etc.), control proceeds to 332 to cue the driver of the preferred escape side, which may be a left or right side of the vehicle determined to have the safest likelihood for an evasive steering maneuver. The cue may include any suitable notification, such as the example visual indications, audio alerts and steering wheel nudge notifications described herein.

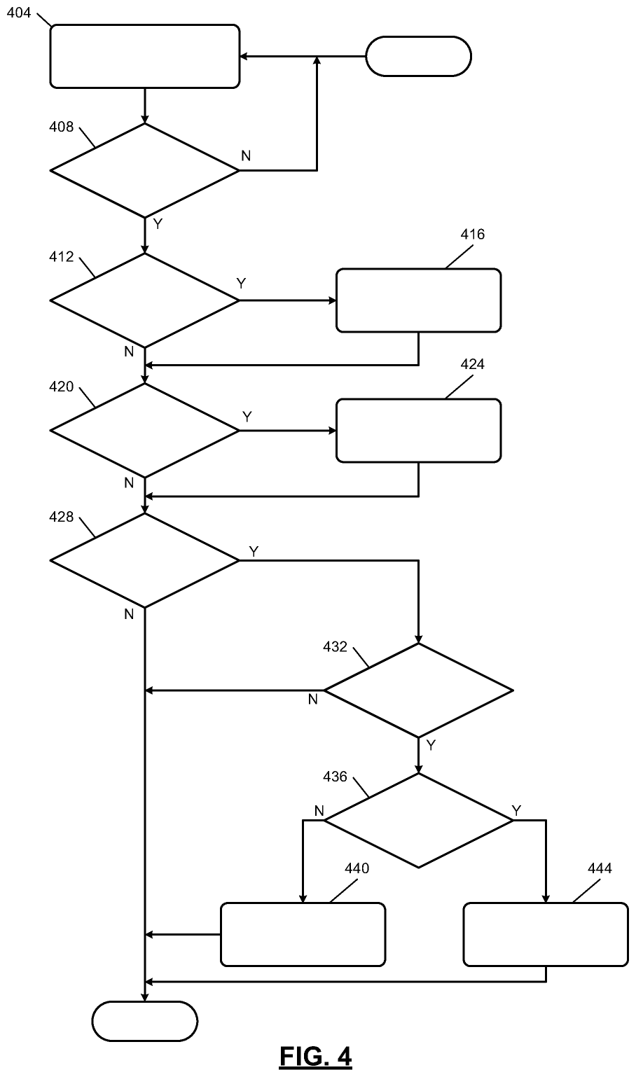

FIG. 4 is a flowchart depicting an example process for determining a type of alert for an evasive steering maneuver. The process may be performed by, for example, the vehicle control module 20 of FIG. 1. At 404, the method begins by monitoring for automated emergency steering (AES) cue requests.

If an AES cue is requested at 408 (such as because a TTC is less than a threshold for recommending an evasive steering maneuver), control proceeds to 412 to determine whether a visual alert has been selected (e.g., specified in alert settings of the vehicle control module 20). If so, control issues a visual alert to the driver via a vehicle user interface at 416.

At 420, the vehicle control module is configured to determine whether a non-visual alert has been selected. If so, control proceeds to 424 to issue an audio chime, a haptic alert (such as vibration of the steering wheel or vehicle seat), etc. The audio alert may include a voice indication of a recommended steering turn to the right or left, or a directional chime sound based on playing audio in different speaker sides of the vehicle, etc.

At 428, the vehicle control module is configured to determine whether a driver is hands-on at 432. For example, the vehicle may include one or more sensors configured to determine whether a driver currently has at least one hand on the steering wheel. If so, control proceeds to 436 to determine whether the vehicle has a steer-by-wire (SBW) system.

If the vehicle has a SBW system at 436, control may apply steering torque to only the steering wheel, without applying any steering torque to wheels of the vehicle. If the vehicle does not have a SBW system, control may apply steering torque to the steering wheel at 440 which also affects steering input to the wheels via a mechanical connection.

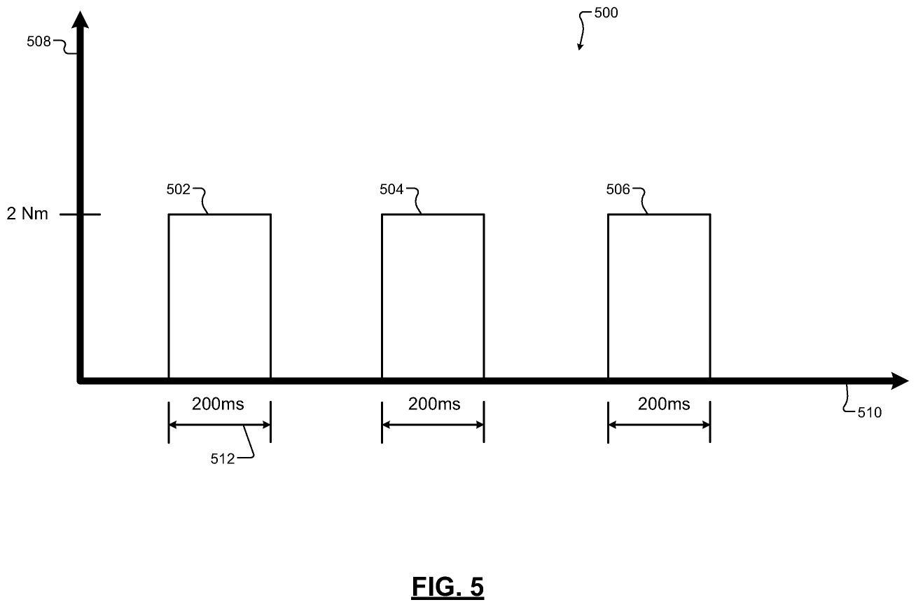

FIG. 5 is graph depicting an example process for providing pulses to apply steering wheel torque. As shown in FIG. 5, a series 500 of pulses is applied to gently rotate the steering wheel. The first pulse 502, the second pulse 504 and the third pulse 506 are spaced apart from one another.

Each pulse may have a specified length, such as 200 milliseconds. The pulses may have same or different lengths, or may be spaced apart by same or different amounts. For example, pulses may increase in frequency until the driver initiates an evasive steering maneuver.

Each pulse may have a specified magnitude, such as about 2 Nm of torque. Each pulse may have a same or different magnitude. For example, each pulse may increase in force until the driver initiates an evasive steering maneuver. Although FIG. 5 illustrates multiple pulses, in some example embodiments a single steering torque pulse may be applied to the steering wheel.

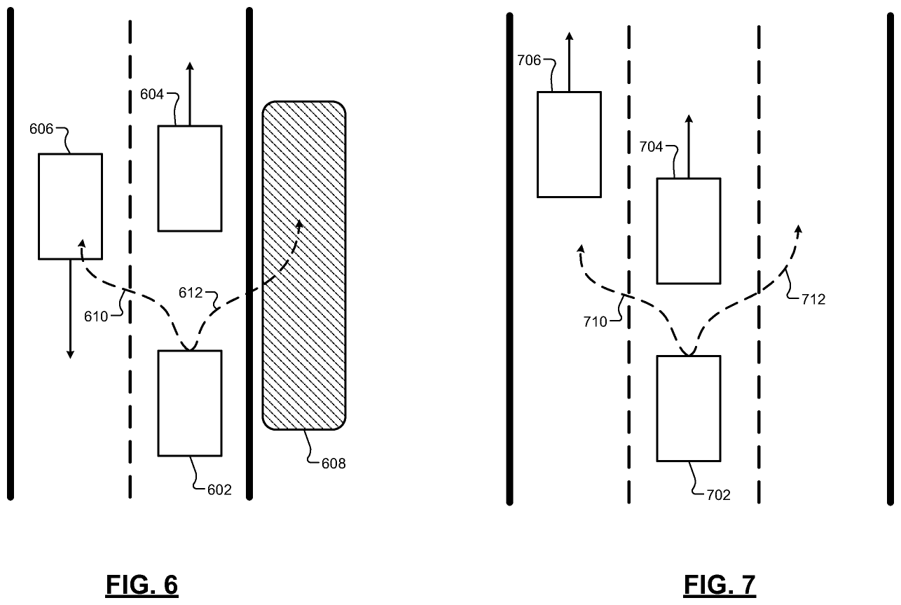

FIGS. 6 and 7 are diagrams illustrating example embodiments for determining a preferred side of the vehicle for an evasive steering maneuver. As shown in FIG. 6, a first vehicle 602 is approaching a second vehicle 604, while a third vehicle 606 is travelling in an oncoming lane.

In response to a vehicle control module of the first vehicle 602 determining that a TTC with the second vehicle 604 is less than a specified time threshold, for example, the vehicle control module may determine whether there are any available escape paths for the first vehicle 602 to steer around the second vehicle 604.

For example, the vehicle control module 602 may determine whether a left side escape path 610 would result in a safe evasive steering maneuver. As shown in FIG. 6, the third vehicle 606 is travelling in an oncoming lane, indicating that the left side escape path 610 is not available. A vehicle in an oncoming lane may be considered as a hard constraint which inhibits or prevents the escape path on that side from being further considered as a candidate for an evasive steering maneuver.

As shown in FIG. 6, the right side escape path 612 would run into a road hazard 608 (such as a wall, a steep embankment, etc.), indicating that the right side escape path 612 is not available. In the example of FIG. 6, the vehicle control module may determine that no safe escape paths are available, and therefore the vehicle control module will not provide an evasive steering recommendation.

In FIG. 7, the first vehicle 702 is approaching the second vehicle 704, with a third vehicle 706 traveling in a same direction in an adjacent lane, up ahead of the second vehicle 704. In this example, the vehicle control module of the first vehicle 702 may determine that both the left side escape path 710 and the right side escape path 712 are available (e.g., because there are not any hard constraints such as an oncoming vehicle or a road hazard on either side of the first vehicle 702).

In this example, the vehicle control module of the first vehicle 702 may use one or more soft constraints to determine which of the left side escape path 710 and the right side escape path 712 is the preferred escape path (e.g., which has the higher likelihood of a safe evasive steering maneuver). The vehicle control module may determine that the right side escape path 712 is the preferred escape path, because although both sides have space for the first vehicle 702 to steer, the right side escape path 712 if free of any vehicles at all.

In some example embodiments, a preferred side escape path may be based on one or more of collision hard constraints, road topology hard constraints, and host vehicle motion hard constraints. Example collision hard restraints may include, but are not limited to, a collision risk with oncoming traffic, a collision risk with a side threat, a collision risk with a front threat, a collision risk with a rear threat, a collision risk with hard barriers, and a low object detection confidence.

Example road topology hard constraints may include, but are not limited to, crossing hard barriers, crossing non-drivable space, and a low lane detection confidence. Example host vehicle motion hard constraints may include, but are not limited to, a lateral velocity above a safety limit, a lateral acceleration above a safety limit, a yaw rate above a safety limit, a lateral jerk above a safety limit, steering above a safety limit, and a steering rate above a safety limit.

The hard constraints may be combined using any suitable algorithm, such as matrix operations including multiplying and summing parameter values for each constraint in each category, comparing parameters to threshold values, etc. If a side of the vehicle has a sensed parameter score for hard constraints above a hard constraint threshold value, that side may be discarded as a possible escape path due to unsafe steering maneuvers on that side of the vehicle.

In some example embodiments, soft constraints may be used to determine which side of the vehicle has a preferred (e.g., safest) escape path, when neither side has been ruled out based on the hard constraints. For example, soft constraints may include actor kinematic soft constraints, road topology soft constraints, host vehicle motion soft constraints, etc.

Example actor kinematic soft constraints may include, but are not limited to, lateral distance to front threat, longitudinal distance to front threat, lateral distance to side threat, longitudinal distance to side threat, relative velocity with side threat, relative acceleration with side threat, lateral distance to rear threat, longitudinal distance to rear threat, relative velocity with rear threat, relative acceleration with rear threat, adjacent actor predictability, and object detection confidence.

Example road topology soft constraints may include, but are not limited to, lateral distance to oncoming lane, lateral distance to road barriers, lateral distance to non-drivable space, adjacent lane width, adjacent free space, adjacent lane marker type (where dashed lane marker lines are penalized less than solid lane marker lines), adjacent barrier type, adjacent view range, adjacent lane curvature, and adjacent lane detection confidence.

Example host vehicle motion soft constraints may include, but are not limited to side overlap with front threat, lateral velocity, lateral acceleration, longitudinal velocity, longitudinal acceleration, longitudinal jerk, lateral jerk, yaw rate, yaw acceleration, steering actuation effort, and braking actuation effort.

The soft constraint parameter values may be combined using any suitable algorithm, such as matrix multiplication and addition, comparing values to thresholds, etc. Scores for left and right sides may be compared, and the side with the lowest soft constraint score may be selected as the preferred side for a recommended evasive steering maneuver (e.g., due to having a greater likelihood of safety for the steering maneuver).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle control system for evasive steering maneuvers, the vehicle control system comprising:
at least one forward object detector configured to detect one or more objects in a driving path of a vehicle;
a steering wheel configured to control a steering direction of the vehicle;
a vehicle user interface configured to display a visual indication to a driver and generate audio for the driver; and
a vehicle control module configured to:
identify, via the at least one forward object detector, an object in the driving path of the vehicle;
determine an estimated time to collision with the object; and
in response to the estimated time to collision being less than a specified time threshold, execute at least one of providing a visual indication of a recommended evasive steering maneuver to the driver via the vehicle user interface, generating an audio alert of the recommended evasive steering maneuver, applying steering torque to the steering wheel to indicate the recommended evasive steering maneuver.

2. The vehicle control system of claim 1, wherein the vehicle control module is configured to, in response to the estimated time to collision being less than at specified time threshold, apply steering torque to the steering wheel to rotate the steering wheel about a steering axis of the steering wheel.

3. The vehicle control system of claim 2, wherein the vehicle control module is configured to apply steering torque as a series of individual pulses which are spaced from one another over a time period.

4. The vehicle control system of claim 2, wherein:
the vehicle includes a steer-by-wire vehicle steering apparatus; and
the vehicle control module is configured to apply steering torque to the steering wheel only without applying steering torque to wheels of the vehicle.

5. The vehicle control system of claim 2, wherein the vehicle control module is configured to:
determine whether the driver currently has at least one hand in contact with the steering wheel; and
apply steering torque to the steering wheel only in response to a determination that the driver currently has at least one hand in contact with the steering wheel.

6. The vehicle control system of claim 1, wherein:
the vehicle control module is configured to, in response to the estimated time to collision being less than the specified time threshold, display the visual indication of a recommended evasive steering maneuver to the driver on a display of the vehicle user interface; and
the visual indication of the recommended evasive steering maneuver includes a recommended steering direction for the recommended evasive steering maneuver.

7. The vehicle control system of claim 1, wherein:
the vehicle control module is configured to, in response to the estimated time to collision being less than the specified time threshold, generate the audio alert of the recommended evasive steering maneuver; and
the audio alert of the recommended evasive steering maneuver includes a chime indicating a steering direction for the recommended evasive steering maneuver.

8. The vehicle control system of claim 1, wherein the vehicle control module is configured to:
obtain one or more vehicle operating condition parameters via one or more vehicle sensors; and
determine a preferred steering direction for the recommended evasive steering maneuver, according to the one or more vehicle operating condition parameters, the preferred steering direction indicative of a left or right steering direction have a higher likelihood of safety compared to an opposite one of the left or right steering direction.

9. The vehicle control system of claim 8, wherein at least one the visual indication of the recommended evasive steering maneuver includes the preferred steering direction, the audio alert of the recommended evasive steering maneuver includes the preferred steering direction, or the steering torque applied to the steering wheel to indicate the recommended evasive steering maneuver includes the preferred steering direction.

10. The vehicle control system of claim 8, wherein determining the preferred steering direction includes applying one or more hard constraints to the one or more vehicle operating condition parameters, each of the hard constraints indicative of a parameter value that prohibits selection of a steering direction.

11. The vehicle control system of claim 10, wherein the one or more hard constraints include at least one of a collision with a traffic threat, crossing of a hard barrier or non-drivable space, or current vehicle motion above a safe maneuver threshold value.

12. The vehicle control system of claim 8, wherein determining the preferred steering direction includes applying one or more soft constraints to the one or more vehicle operating condition parameters, each of the soft constraints indicative of a parameter value indicative of lower likelihood of safety of a steering direction.

13. The vehicle control system of claim 12, wherein the one or more soft constraints include at least one of relative distance and motion from a traffic threat, a topology of a road on which the vehicle is travelling, and a current motion of the vehicle.

14. The vehicle control system of claim 1, wherein:
the specified time threshold is a specified second time threshold;
the vehicle control module is configured to initiate a forward collision alert in response to the estimated time to collision being less than a specified first time threshold; and
the specified first time threshold is greater than the specified second time threshold.

15. A method for recommending evasive vehicle steering maneuvers, the method comprising:
controlling, via a steering wheel of a vehicle, a steering direction of the vehicle;
detecting, via at least one forward object detector of a vehicle, an object in a driving path of a vehicle;
determining, by a vehicle control module, an estimated time to collision with the object; and
in response to the estimated time to collision being less than a specified time threshold, executing at least one of:
providing a visual indication of a recommended evasive steering maneuver to a driver via a vehicle user interface of the vehicle;
generating an audio alert of the recommended evasive steering maneuver; and
applying steering torque to the steering wheel to indicate the recommended evasive steering maneuver.

16. The method of claim 15, wherein applying steering torque includes applying steering torque to the steering wheel to rotate the steering wheel about a steering axis of the steering wheel.

17. The method of claim 16, wherein the steering torque is applied as a series of individual pulses which are spaced from one another over a time period.

18. The method of claim 16, wherein:
the vehicle includes a steer-by-wire vehicle steering apparatus; and
applying steering torque includes applying steering torque to the steering wheel only without applying steering torque to wheels of the vehicle.

19. The method of claim 16, further comprising:
determining whether the driver currently has at least one hand in contact with the steering wheel; and
applying steering torque to the steering wheel only in response to a determination that the driver currently has at least one hand in contact with the steering wheel.

20. The method of claim 15, wherein:
displaying the visual indication of a recommended evasive steering maneuver to the driver on a display of the vehicle user interface; and
the visual indication of the recommended evasive steering maneuver includes a recommended steering direction for the recommended evasive steering maneuver.
